(19) United States
(12) Patent Application Publication
(10) Pub. No.: US 2008/0034969 A1
(43) Pub. Date: Feb. 14, 2008

(54) Air Purification by Electromagnetic Rediation of a Dispersed System

(75) Inventors: Troels Koch, Kobenhaven S (DK); Henrik Bohr, Holte (DK)

Correspondence Address: BIRCH STEWART KOLASCH & BIRCH, PO BOX 747, FALLS CHURCH, VA, 22040-0747, US

(73) Assignee: ARKA HOLDING APS, ESPERGAERDE (DK)

(21) Appl. No.: 11/632,169

(22) PCT Filed: Jul. 13, 2005
(86) PCT No.: PCT/DK05/00490

§ 371 Date: May 4, 2007

(30) Foreign Application Priority Data
Jul. 13, 2004 (DK) PA 2004 01104

(51) Int. Cl. B01D 49/00; B01D 53/92; B01J 19/12; F24F 3/16

(52) U.S. Cl. 95/149; 96/243

(57) ABSTRACT

The present invention relates to a method of purifying a flow of a gas, in particular an exhaust gas from a Diesel engine, which is contaminated with a particulate material (e.g. nanoparticles) using an apparatus comprising (i) a conduit for passage of the gas flow, (ii) means for applying electromagnetic radiation, e.g. microwaves, and (iii) means for supplying a dipolar liquid, e.g. water, said method comprising the steps of allowing the contaminated gas to flow through the conduit; and applying the electromagnetic radiation to said gas and said liquid. The invention also relates to an apparatus, e.g. a diesel engine exhaust system for purifying a continuous exhaust gas flow contaminated with particulate material(s), e.g. nanoparticles, in order to reduce the content of nanoparticles.

### FIELD OF THE INVENTION

The present invention relates to removal of particles from air and gasses by using electromagnetic radiation in combination with a dispersed system such as water vapours. The electromagnetic radiation will interact with the particles from the air or gas and the created dispersed system will interact with the particles, by fast dissolution/dispersing/sintering, and the air- or gas-borne impurities will be trapped. The particles can be particles from combustion engines or micro-organisms such as viruses or bacteria. The invention relates also to the use of this principle and it relates to assemblies/devises in which the combined action can take place. Preferred examples of use is the removal of particles in exhaust gas from Diesel engines, removal of micro-organisms, spores and vira in air conditioning systems for purifying air inlet or the bio-safety, and removal for small impurities in inlet air in clean rooms for e.g. the production facilities in the electronic/medicinal industry.

### BACKGROUND OF THE INVENTION

Removal of particles from air is a widely wanted situation. The principle holds for many everyday situations: Removal of side products from combustion engines (automobiles, trucks, busses, ship engines, power plants, mines, heating devises, etc.) using fuel such as petrol, coal, wood, natural gas). The side products are for instance NOₓ or SOₓ from combustion engines that are released at a molecular level and/or particles, such as soot that is dispersed in the outlet of the air stream. Catalysts are rather effective to remove unwanted oxidations products (CO, NOₓ, SOₓ) in a molecular level by reducing those, and large particles such as large soot particles arising from un-complete combustion can be reasonable effectively removed by classical filter techniques, e.g. ceramic filters. However, filters, even coarse filters, are draining the engine a significant amount of energy. Filters may remove the large particles (>100 μm) but they cannot efficiently remove the very small and fine particles. It is now well known that the fine particles (diameter of <1 μm; nanoparticles) constitutes a significant health hazard, and some researchers claim that the emission of fine particles is the biggest health hazard in contemporary urban areas. It is estimated that hundreds of thousands of people are dying annually world-wide as a consequence of nanoparticle induced diseases such as cancer and other malignancies in the aerial tracts and systemically.

Removals of particles are also important in air conditioning or air cleaning systems. It is very important for a healthy indoor environment that the ventilated air is not carrying health hazards that will impair the indoor climate. Such hazards are, e.g., particles of either inorganic or organic nature arising from, e.g., combustion engines such as dust or soot, and blo-hazards such as bacteria, spores and viruses. Clean air is in particular important in “clean rooms” used in manufacture and production of semi-conductor and silicon wafer equipment, in the biochemical industry, in hospitals and the like where the contact of “non-air” entities in air can cause damages to equipment or to health hazards to people.

Air cleaning can also be important from a bio-defence purpose. For instance extreme exposure of micro-organisms such anthrax, small pox, SARS, Ebola, or other airborne either viruses or bacteria can be very important to have removed. In particular, viruses are difficult to remove due to their small size and viability.

Various methods for removing particles arising from combustion engines e.g. Diesel engines using microwave technology have been described.

Burning/Oxidation of Particles

For example EP221805-A discloses a method where microwaves are used to burn carbonaceous particles in a circulating gas through a resonant structure. DE4236242-A discloses a method of removing carbon particles by operating a stationary oxidative plasma process achieved by microwaves in a combination with excess oxygen using fuel and atmospheric air.

WO 00/43106 discloses a method for oxidizing lower valence compounds such as nitric oxide from gaseous streams by means of microwave irradiation and an oxidant.

US 2004/120845 A1 discloses a method of neutralising spores and/or pathogens by means of ozone and UV light. It is mentioned that microwave irradiation can be used to break down spore coatings and make spores more susceptible to ozone.

U.S. Pat. No. 6,284,202 B1 discloses a method of removing NOₓ and other pollutants from an exhaust gas stream. The process may be enhanced by application of microwaves.

Burning of Particles on Filters

GB2080140-A is disclosing use of a non-metallic filter used to trap soot particles after which a microwave radiation will burn the particles.

Also EP412019-B1 is disclosing a method and device from which it is possible to burn trapped particles from a Diesel engine by using microwave radiation of said filter device. EP327439-A discloses an exhaust gas filtration system for a Diesel engine using a combination of a filter and microwaves. The disclosure relates to the use of a mode of excitation of a cylindrical cavity comprising a resonator suited to the use of ceramic filters available in the industry.

Filter Cleaning

DE401-4453-A is describing use of microwaves for cleaning ceramic filters in which soot particles have been trapped.

FR2701514-A1 is disclosing the used of a dual filter system where the filter not currently used to filter exhaust gas can be cleaned by the use of microwaves.

EP635625-A discloses a process where ceramic particle filters for Diesel engines are cleaned by use of microwaves. In this method the settled soot particles are combusted in the presence of excess oxygen and fuel.

CN1441153 discloses a device including a catalyst in which the microwave radiation will remove the settled particles emitted from a Diesel engine and regenerate the catalyst.

JP9287434 is disclosing an apparatus for reclaiming a filter. The filter is used to settle the particles and the particles are then burned in the presence of oxygen and microwaves.

FR2809766-A discloses the regeneration of a filter for Diesel engines by which the filter is heated with microwaves and oxidizing gases are injected. The process removes the particles by oxidation.

U.S. Pat. No. 5,087,272 (WO9206769) discloses a filter heater structure in which a monolithic filter, silicon carbide, is used to remove the particles from the gas. The electromagnetic radiation energy from microwaves is converted to heat on the filter. The heat will volatilise the settled particles that discharge as gas.

All of the above-mentioned disclosures relates to the use of microwaves to burn or to clean traditional filters that preferentially are non-metallic (e.g. ceramic). In all cases, microwaves are used after retention of the particles by the filters and not before and during settlement of the particles. Thus, microwaves are used to remove particles not in the state of an aerosol but as stationary material.

There have only be disclosed a few examples on how air-cleaning systems of various kinds using microwaves have been disclosed:

WO03045534 A1 discloses an air cleaning system comprising several elements: 1. A housing containing an in-let for impure air and an outlet for purified air; 2. A pump for pumping anti-microbial ions (e.g. halogen gases) into the purifying chamber; 3. At least one microwave source; 4. Oxidizing agents and 5. A filters for removing incoming particles and for removing released anti-microbial ions. The microwave radiation is to be used for activating the halogen gas so that the gas can kill the micro-organisms.

CN1456357-A discloses an air purification system where microwaves are used in combination with an inlet filter, an activated layer, and ultraviolet light in the same casing for killing micro-organisms.

For both of these disclosures the contaminants are trapped on filters and the microwaves are used to heat the air and the system or to activate cleansing chemicals so that purification and killing of micro-organisms occur.

### SUMMARY OF THE INVENTION

This invention relates to the surprising discovery that the combination of electromagnetic radiation, e.g. microwaves, and vapours or aerosols of a dipolar liquid, e.g. water, provide a very powerful potential for removing particles from air. This water aided microwave filtration (or WAIM technology) constitutes a novel non-invasive filtering system. The WAIM technology is very simple and facilitates effective air purification.

Microwaves (e.g. of a frequency of 2.24 GHz) are effectively absorbed by water. The electromagnetic energy is converted into heat. Boiling water releases steam that is a dispersed system where air is the dispersing medium and water is the dispersed phase. Microwaves can interact with particles and with the steam/fog and transfer the energy to these systems. Hot water vapours have very high dissolving/dispersing properties and a hot water vapour have a very large surface.

The combination of the large surface and the hot vapours is important for the WAIM-effect.

The exact mechanism behind this observation is not fully known but it is a fact that the combination of microwaves and water droplets provide the unique properties that the individual parameters do not exert. A likely explanation for the effect is that the microwaves interact and polarize the airborne impurities so that the vapours can, due to a polar nature of e.g. water molecules, bind to and take up the particles and the vaporized molecules. The surface tension of water droplets will also bind the polarised particles. Furthermore, experiments have shown that microwave radiation enhance the process of particle aggregation. Microwaves alone trap and aggregate small particles less efficiently.

Without being bound to any particular theory, it is suggested that the phenomena of water vapor together with microwave radiation causing small particles to agglomerate may be explained as follows.

Small combustion particles at the nano-scale in hot water vapor absorb water molecules. These are strongly polar molecules. Under influence of microwaves (predominantly strong electric fields) the complex composed of the combustion particles and adsorbed water molecules will be strongly polarized and oscillate. This leads to an enhancement of aggregation and agglomeration. The oscillation is determined by the frequency of the microwave radiation and the strength of the electric field gradient. Furthermore, it is dependent on the elasticity and Young's modulus. The rate of aggregation is both dependent on the oscillation and the surface tension of the particles. The formula for the resonance frequency, v, is given by
v=1/(π×r)×sqrt(E×r/ρ)
where r is the radius of the particles, E is the Young's modulus of the particles and ρ is the density of the material constituting the particles. The amount of adsorption is given by:
V/V_{M}=(KP/(1+KP))ⁿ
where V is the volume (at standard condition) of gas adsorbed per unit amount of solid, V_{M} is the volume adsorbed at saturation, P is the partial pressure of adsorbate and K is a suitable constant of the material.

### BRIEF DESCRIPTION OF THE FIGURES AND DRAWINGS

FIG. 1: is showing a generic structure showing the elements of an assembly (an apparatus) exerting the WAIM-effect. It is important to underline that is it only the various functional elements that are shown; the actual design may differ significantly from this drawing, and may differ from application to application. (1) refers to the pipeline from, e.g., a combustion system (e.g. a Diesel engine) or a ventilation system. (2) refers to a section of the zone wherein water vapour is generated, e.g. by condensing a hot exhaust gas or by addition of water. (3) refers to a section of the zone wherein electromagnetic radiation, e.g. microwave radiation, is applied. (4) refers to a section wherein impurities are collected by sedimentation or condensation.

FIG. 2: Scanning electron microscopy (SEM) picture at 25.000 and 250.000× magnification showing untreated Diesel exhaust gas particles taken directly from the exhaust pipe.

FIG. 3: SEM picture at 25.000× magnifications. The sample is collected at the outlet of the microwave oven without the magnetron ON and without hot water vapour in the oven.

FIG. 4: SEM picture at 25.000× magnifications. The sample is collected at the outlet of the microwave oven with the magnetron ON and without hot water vapour in the oven.

FIG. 5: SEM picture at 25.000× magnifications. The sample is collected at the outlet of the microwave oven with the magnetron ON and with water not boiling in the oven.

FIG. 6: SEM picture at 12.500× magnifications. The sample is collected at the outlet of the microwave oven with the magnetron ON and with hot water vapour in the oven.

FIG. 7: SEM picture at 25.000× magnifications. The sample is collected at the outlet of the microwave oven without the magnetron ON but with water boiling in the oven to create water vapours.

FIG. 8: SEM picture at 25.000 and 50.000× magnifications. The sample is taken from the inside of the oven after the experiments to demonstrate how the aggregated/sintered particles appear after WAIM.

FIG. 9: Particle size distribution for a sample collected from a Diesel exhaust gas from a hot engine without microwave application and without addition of water vapour.

FIG. 10: Particle size distribution for a sample collected from a Diesel exhaust gas from a hot engine without microwave application but with addition of water vapour.

FIG. 11: Particle size distribution for a sample collected from a Diesel exhaust gas from a hot engine with microwave application and with addition of water vapour.

### DETAILED DESCRIPTION OF EMBODIMENTS

The Method of the Invention

The present invention is particularly useful for the purification of a flow of a gas which is contaminated with a particulate material. Thus, the present invention provides a method of purifying a flow of a gas which is contaminated with a particulate material using an apparatus comprising (i) a conduit for passage of the gas flow, (ii) means for applying electromagnetic radiation at a frequency of in the range of 10 MHz to 100 GHz in at least one zone within said conduit, and (iii) means for supplying a dipolar liquid to said zone of said conduit, said method comprising the steps of

(a) allowing the contaminated gas to flow through the conduit; and

(b) applying the electromagnetic radiation to said gas and said liquid in said zone of said conduit.

The flow may originate from a combustion engine, in particular a Diesel engine, from air-condition systems, air-filtration systems for clean-rooms, etc. In a particularly interesting embodiment which represents a source of environmentally harmful nanoparticles, the flow is from the combustion system of a Diesel engine, i.e. the exhaust gas of a Diesel engine.

Thus, in a particularly interesting embodiment, the present invention provides a method of purifying a flow of an exhaust gas from a Diesel engine which is contaminated with a particulate material, in particular nanoparticles, using an apparatus comprising (i) a conduit for passage of the exhaust gas flow, (ii) means for applying electromagnetic radiation at a frequency of in the range of 10 MHz to 100 GHz in at least one zone within said conduit, and (iii) means for supplying a dipolar liquid to said zone of said conduit, said method comprising the steps of

(a) allowing the contaminated gas to flow through the conduit; and

(b) applying the electromagnetic radiation to said gas and said liquid in said zone of said conduit.

The particulate materials relevant in the present context may be of fairly diverse types, e.g. soot particles, dust, and microorganisms, vira, cells, etc., as will be explained in the following.

In the above methods, the dipolar liquid, in particular water, is preferably introduced into the zone in the form of a vapour or an aerosol, or is turned into a vapour or an aerosol upon application of the electromagnetic radiation.

In some embodiments, the density of particles is very low after purification of the gas, e.g. such that the density of the particulate material is less than 10¹⁵ particles per m³ in the gas exiting the conduit.

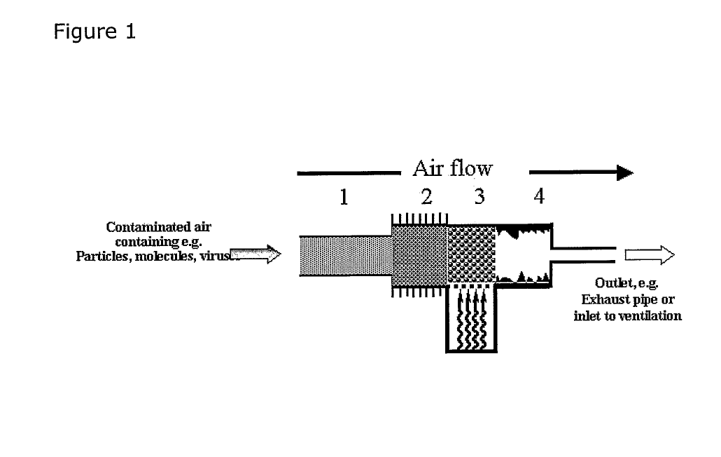

By means of the method of the present invention, it is possible to dramatically reduce the number of very small particles, e.g. such that the number of nanoparticles (a particle having a size (diameter) of less than 1 μm) in the gas is reduced by at least 20%, or at least 30%, such as at least 40%, or at least 50%, e.g. at least 60%, or at least 70%, or even at least 80%, or at least 90%, preferably substantially eliminated. The reduction is determined by comparing the number of nanoparticles at the inlet portion of the apparatus (e.g. (1) in FIG. 1) and the number of nanoparticles at the outlet of the apparatus. In Examples 2 herein, the reduction of the number of nanoparticles is clearly demonstrated.

In order to interact with electromagnetic radiation, the molecules of the dispersed phase (the dipolar liquid) or the structures that the molecules exist in, e.g. in solution and as dispersed phase, must have a significant dipole moment. In the present context, the term “dipolar liquid” is intended to mean that the dielectricum constant, K, for the liquid is larger than 10 (Air: K=1). Illustrative examples of dipolar liquids are water, alcohols, nitriles, nitro-compounds, ethers, and carboxylic acids. Non-oxidising and non-reducing dipolar liquids are currently preferred in that the method of the invention does not rely on an oxidative or reductive action of the dipolar liquid.

Water is believed to be the most useful dipolar liquid due to its availability and non-toxic properties.

The dipolar liquid, e.g. water, may be present as an aerosol (droplets), or as a vapour (i.e. in gaseous form). It is currently believed that the aerosol or droplet form is preferred over the vapour form.

Depending on the number of particles in the gas to be treated, the amount of the dipolar liquid can be varied. Typically, at least 10 grams, such as at least 50 grams, or at least 100 grams of vapour and/or aerosols of the dipolar liquid, e.g. water, are supplied per m³ per minute, e.g. 200-2000 g/m³/min or 50-500 g/m³/min. The volume (stated as m³) refers to the volume of the zone in which radiation with microwaves takes place.

The passage time for the gas through said at least one zone where electromagnetic radiation is applied is typically in the range of 0.01-100 s, such as 1-10 s. Sometimes the passage time is fairly short, e.g. 0.005-2 s, or 0.01-1 s.

The effect density of the electromagnetic radiation in said zone is typically in the range of 0.01-50 kW/m³, e.g. 0.1-10 kW/m³ or 0.05-5 kW/m³. Again, the volume (stated as m³) refers to the volume of the zone in which radiation with microwaves takes place.

The present invention relies on electromagnetic radiation of a dispersed system. The generator of the electromagnetic radiation in the illustrated examples is a magnetron from a domestic microwave oven (2.24 GHz) and the dispersed system is exemplified by using a water vapours. It is known that water absorbs electromagnetic radiation in a broad range around 2.24 GHz and up to about 100 GHz, so it is therefore also part of this invention to used frequencies other that 2.24 GHz. Thus, frequencies in the range of 10 MHz to 100 GHz may generally be used, in particular frequencies in the range of 500 MHz to 100 GHz, e.g. 915 MHz, 2450 MHz, 5800 MHz and 22,125 MHz. Other dispersing phases than water aerosols can be used. The fact that most of the present experiments have been employing the standard 2.24 GHz magnetrons is due to the costless effectiveness of the magnetron. Other frequency choices of frequencies for the electromagnetic radiation effect described here are also to be used and it is highly likely that more optimal frequencies can be found. Thus, it is possible to determine for a particular system, e.g. Diesel exhaust for automobiles, an optimal frequency for the WAIM-effect.

The WAIM effect is obtained by producing a dispersed system that is used to disperse/dissolve impurities from another dispersed system after which the air-flow is purified. In one embodiment of the present invention, aerosols from combustion engines are passed thorough an assembly (FIG. 1, and vide infra) saturated with hot vapour from a water source. The particles and the hot vapour are simultaneously activated with electromagnetic radiation. The water can be applied “externally” by having a liquid water inlet. The main products from combustion are water and carbon dioxide. Due to the temperature, water as the product from the combustion is in the gas phase just as the carbon dioxide. However, if the exhaust outlet is cooled the water gas will condense and droplets/fog will be created. The white smoke rejected from cars during winter or from jet-flights in the sky is condensed water produced by the combustion. If the condensed water and the particles are activated with electromagnetic radiation the WAIM-effect will occur.

It is therefore also an embodiment of the present invention to generate the hot fog ‘internally’ by condensing directly on the exhaust gas and then activate with electromagnetic radiation to obtain the WAIM-effect. Thus, a WAIM assembly could comprise a condensing unit in or after which the electromagnetic radiation is applied. In a preferred embodiment the temperature of the condensing unit should be in the range of 0-100° C. to condense the water gas, even though the temperature may transitionally during condensing be below 0° C. in the unit. The water containing the dissolved/dispersed molecules or particles may subsequently be collected and disposed in a safe manner. When water gas condenses, the gas molecules are first collected as very small droplets that then are growing in to larger drops. It is therefore an important embodiment of the present invention to apply the electromagnetic radiation directly at that time in the progressing water condensation sequence where the combined effect by the electromagnetic radiation on the air-impurities and on the water vapour has the optimal interaction. Subsequent to the WAIM-effect safe disposal of the contaminated water can then occur. For instance in automobiles, the water that has trapped the air-borne impurities/particles can be released by “dripping of” during driving, or it can be collected for subsequent disposal.

The exact determination of the relation between frequency and state of the dispersed system can be different from application to application. E.g. the assembly system exerting WAIM could likely be different in Diesel cars and in large Diesel engines on ships. The WAIM-assembly can also be used in sequential to other purifying assemblies such as catalysts, for gas reductions, and coarse filters for removal of large particles. Another embodiment of the present invention is to use WAIM to remove particles from other combustion sources such as power-plants and heating systems.

The advantage of WAIM is that it removes the finest particles in a non-invasive manner. Traditional filters will not be able to remove the finest particles (including nanoparticles).

Another embodiment of this invention is the used WAIM to filter impurities in inlet air in clean rooms. In the computer industry, an extreme high level of purity is needed for the production of silicon wafers and other semiconductor equipment, and in the medical industry an extreme high level of purity is also needed for the safe production of the active ingredients or kits to be used in human health care. For instance in the production of silicon wafers the air has to be free from boron compounds that can be released from the filters in traditional air-purification systems during the manufacturing process.

In one embodiment of an air-purification system, the water needed for the WAIM-effect will in most cases be added externally and after the WAIM filtration the water is condensed to dissolve/disperse the impurities. The water can be recycled for subsequent WAIM action or be collected for safe disposal.

Another embodiment of this invention is to provide better bio-safety. When micro-organisms are dispersed in the air, e.g. viruses such as anthrax, they can be trapped in the activated hot water vapour generated by WAIM. The micro-organisms will be retained in the water droplets and killed in the dual action of electromagnetic radiation and hot vapour.

In another embodiment of the present invention, condensation of the hot water gas emitted from e.g. Diesel automobiles can be cooled to reach condensation temperature by spraying the exhaust gas with cold water. This treatment with cold-water droplets will cool the hot water gas generated during the combustion to create an even more dense dispersed system of water droplets and air. This treatment must be performed before the gas is let into the irradiation chamber, i.e. in chamber 1 (FIG. 1). The condensed gas containing the impurities is let into chamber 2 and the electromagnetic radiation is applied (chamber 2) and the sintered particles/impurities are sintered/settled (chamber 2-3). After this treatment, the condensed water can be collected in a separate container, e.g. by applying cooling, and the water can be collected. The collected water can now be recycled and let back to be used as cooling/condensation agent by spraying the hot exhaust gas in chamber 1. In this way, the hot water gas generated by the combustion can be cooled by water to reach the condensation point and thereby creating the dense dispersed system needed in combination with electromagnetic radiation to collect the impurities in the gas stream. By condensation and collection of the water, after the treatment with electromagnetic radiation and sedimentation of the impurities, the water can be recycled and used again to cool/condense the hot water gas generated by the combustion.

Thus, one embodiment of the method includes the further step of collecting and recycling at least a portion of the dipolar liquid, e.g. water.

The Apparatus of the Invention

The present invention also provides an apparatus which is particularly useful in combination with the method of the present invention. Thus, the present invention provides a method for purifying a continuous gas flow contaminated with particulate material(s), said apparatus comprising (i) a conduit for passage of the gas flow, (ii) means for applying electromagnetic radiation at a frequency of in the range of 10 MHz to 100 GHz in at least one zone of said conduit, and (iii) means for supplying a dipolar liquid, preferably water, to said zone of said conduit.

In one particularly interesting embodiment, the apparatus is used as a part of the exhaust system of a Diesel engine. Thus, the present invention further provides a diesel engine exhaust system for purifying a continuous exhaust gas flow contaminated with particulate material(s), said exhaust system comprising (i) a conduit for passage of the exhaust gas flow, (ii) means for applying electromagnetic radiation at a frequency of in the range of 10 MHz to 100 GHz in at least one zone of said conduit, and (iii) means for supplying a dipolar liquid to said zone of said conduit.

The supply of dipolar liquid is particularly relevant for suitable operation of the apparatus. In one embodiment, the means for supplying water to said zone is arrange within said zone of the conduit. In another embodiment, the means for supplying water to said zone is arranged upstream relative to the zone so that the water is carried with said flow of contaminated gas to said zone.

In a particular embodiment, the apparatus comprises means for collecting agglomerated particulate material(s), said means being arranged downstream relative to said zone. The means of collecting can be arranged as illustrated in FIG. 1 (4). In one embodiment, the means for collecting is a filter.

The optimal design of the WAIM-assembly is related to several basic issues. Flow speed of the air, generation of the dispersed phase, and most optimal design of the reactor in which the electromagnetic radiation is performed. In designing the optimal dimensions of the reactor the frequency of the electromagnetic radiation is probably of great importance. Microwave wave-guides and cavities are used in which the dimensions are calculated to fit the wavelength of microwaves. It is part of this invention to use carefully calculated cavities fitted for the calculated optimal electromagnetic radiation for a particular system. It is important that the particles and the dispersed phase are activated where the intensity of the electromagnetic radiation is the highest and where the interaction, polarisation, of the contaminants are the most optimal. If it is calculated that another frequency than the frequency of microwaves are best, the dimensions of the reactor might be changed. Design of the WAIM-assembly comprises several steps:
1. Characterisation of the system and assigning the optimal absorption/interaction by the electromagnetic radiation.
2. Creation of the dispersed system, e.g. water vapours, for optimal dissolving/dispersing of the air-borne impurities by “internal” (e.g. condensing) or “external” methods.
3. Determination of optimal dimensions of the radiation reactor, e.g. a careful calculated cavity.
4. Design of the chamber where sedimentation of dissolved/dispersed impurities is occurred.
5. Optionally recycling systems for recycling the dispersing phase.
6. Disposal routes, and chambers, for the concentrated impurities or for the condensed dispersed phase.
7. Overall design issues aimed to tailor make the assembly to a particular application.

It is highly likely the WAIM-assembly will differ from system to system, frequency to frequency, differentiated optimal dispersed phases, and application to application. The generic elements of a WAIM-assembly are shown in FIG. 1. The compartments are:
1. An inlet of the flow of contaminated air.
2. Generation of the hot dispersed phase. In case of water, it can be obtained either by condensation of very hot air or by heating of cold water.
3. The zone wherein irradiation of the dispersed system comprising hot vapour and contaminated air with electromagnetic radiation takes place.
4. Collection of the trapped impurities by WAIM-sedimentation. The collection device can be in the same reactor where the electromagnetic radiation is generated or in a separate chamber.

After the treatment, the outlet will carry some water and some dissolved/dispersed impurities that can be collected by condensing the water. The condensed material can also be released together with the dispersed phase, e.g. dissolved/dispersed in the water droplets.

Subsequent heating and re-generation of hot water vapours will recycle the water used for the purification.

The collected contamination products can subsequently be removed from the collection devise by e.g. heating and burning off of the collected material as described for the soot removal of ceramic filters in the prior art. In such a particle cleaning system electromagnetic radiation, e.g. microwaves, can be used to enhance “burning off” the aggregates.

Thus, one embodiment of the apparatus (and exhaust system) comprises means for collecting and recycling at least a portion of the dipolar liquid, e.g. water.

WO 00/43106 also provides examples of elements suitable for the apparatus of the invention.

### EXAMPLES

### Example 1

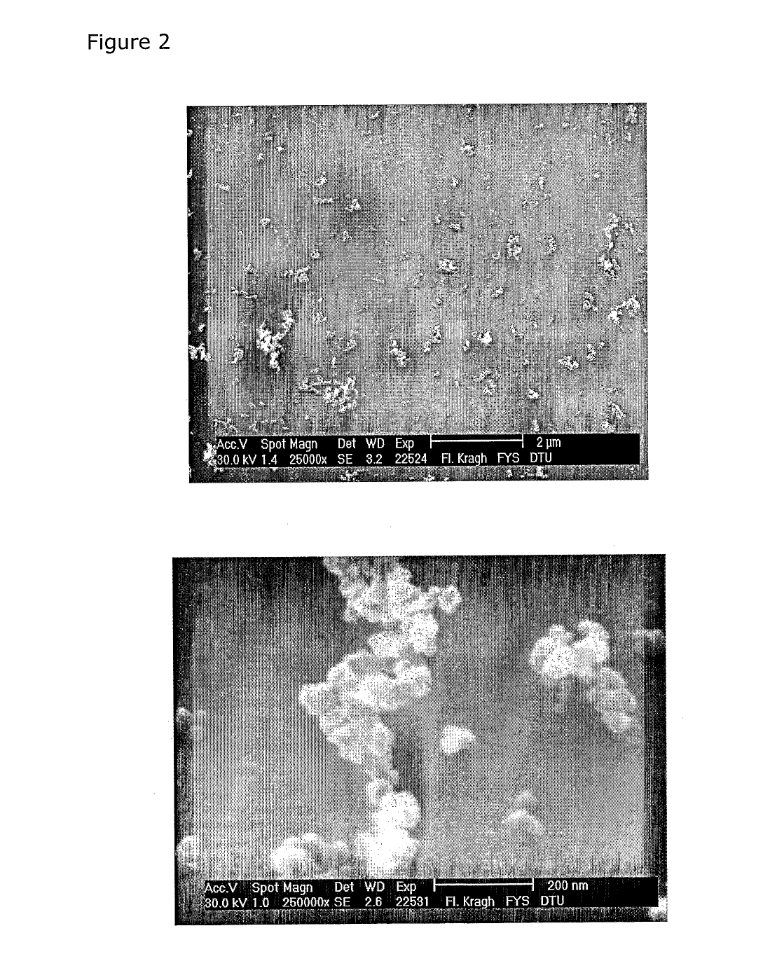

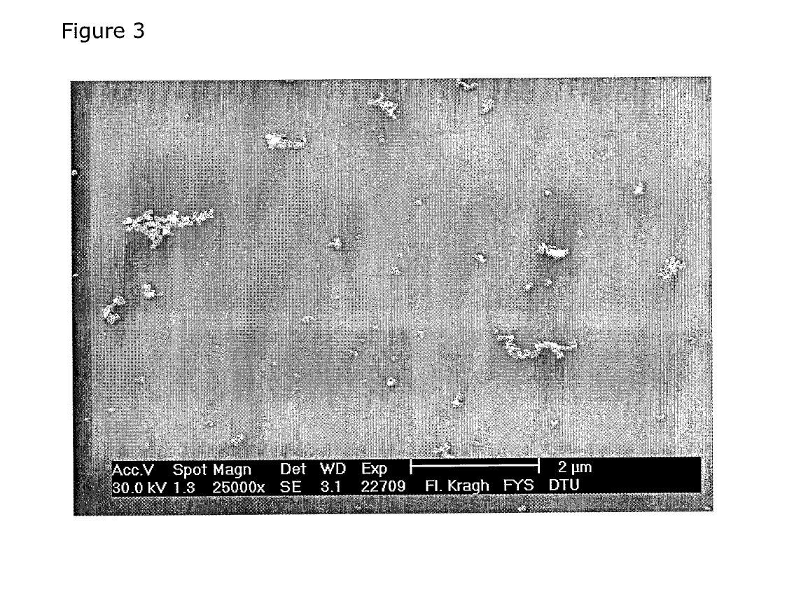

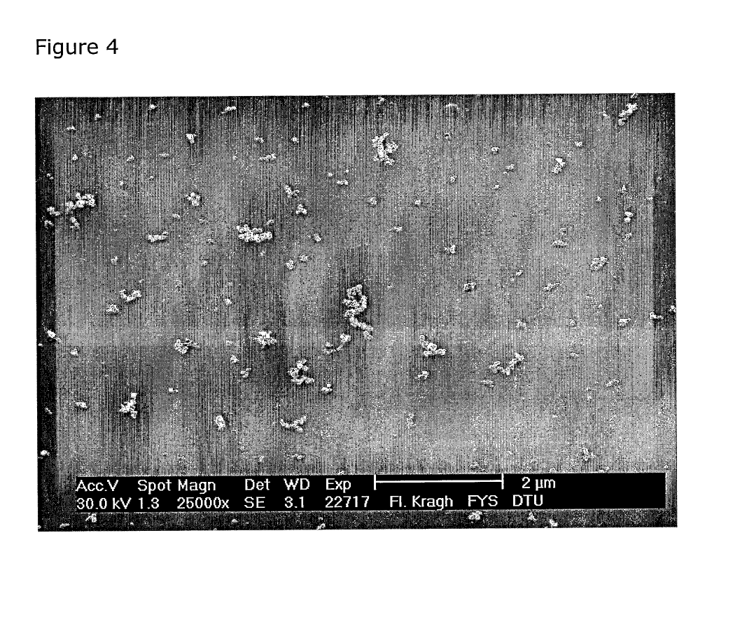

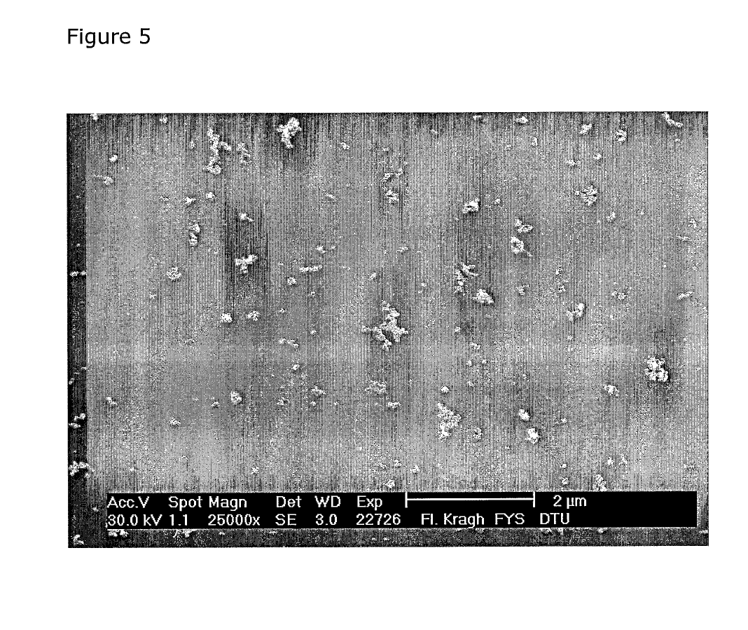

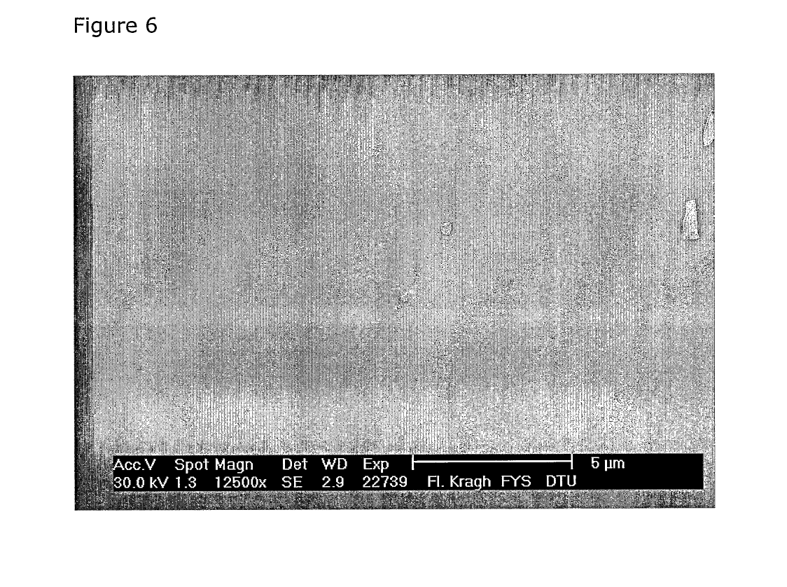

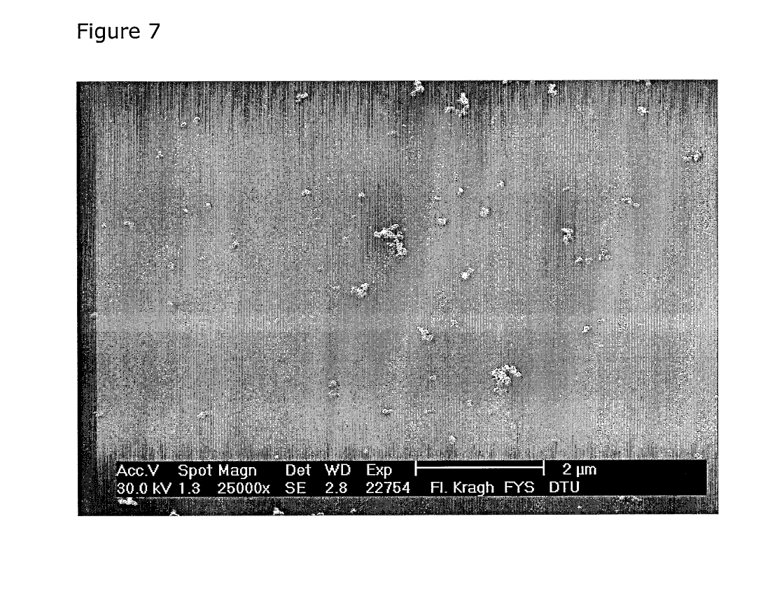

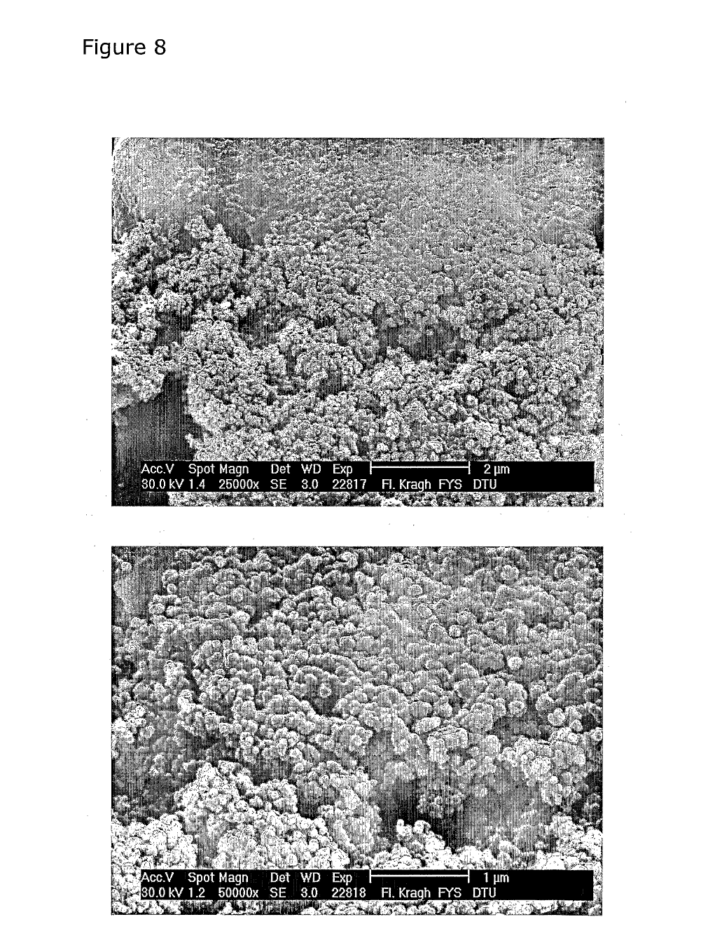

The exhaust gas form an idling Diesel car engine is via a short plastic hose entered into an ordinary microwave oven (volume approx. 15 L). The magnetron is emitting microwaves at a wavelength of 2.24 GHz (800 W). In the microwave oven are made two holes: one for inlet of the Diesel exhaust gas and the other for the outlet. Samples are taken either right before the inlet into the oven or just after the outlet of the oven. The door to the oven is closed during the experiments. The samples (a.-g.—see below) are collected on probes that subsequently are placed in a scanning electron microscope (SEM) for particle analysis or analysed by other particle detection methods. In the subsequent section the probes are analysed by SEM.
a. In the first experiment, a sample is taken directly before the inlet in the oven. On the SEM picture, it is seen that the particles are very fine and rather uniform in size. The particle sizes range from the very finest at about 10 nm to larger aggregates >1 μm. It is seen that the majority of the particles are very fine (FIG. 2) and rather uniformly dispersed. All samples are collected in a continuous Diesel gas exhaust flow for 2 min to secure adequate sedimentation of particles on the probes.
b. The next sample was taken at the outlet of the oven after the exhaust gas has been let into the oven. In this example, the magnetron is not turned “ON”. Thus, the exhaust gas is just let in and out of the oven (FIG. 3). It is seen that there is no difference in the particle pattern compared to sample a.
c. This sample is just as sample b but with the magnetron turned “ON”. It is seen from FIG. 4 that the particle density in the outlet air stream is very high and that there are many very fine particles that pass right through the oven.
d. In the next experiment about 100 mL of water is placed in the oven. During the 2 minutes of collection with the magnetron “ON”, the water does not reach the boiling point. Therefore, no water vapours are formed. In FIG. 5, the particle distribution and density appear to be the same as what is seen for the previous samples.
e. In this example, the water, heated by the microwaves, reaches the boiling point. After this, the exhaust gas is let into the oven while the magnetron it turned “ON”. The water will momentarily start boiling and the oven is immediately filled with hot vapours. During the 2 min of collection, the water is continuously creating a dense hot vapour. As it can be realised from FIG. 6, no particles were detected at the outlet of the oven, even at a very low magnification. Even after extensive inspection, it was not possible to detect any relevant particle structures.
f. In order to test if hot water vapours were the only active parameter, a 100 ml water container was heated on a hotplate. The hotplate+hot water was placed in the oven and the hotplate was turned “ON”, the door was closed, the exhaust gas was let into the oven and particles were collected for 2 min at the outlet. The magnetron was not turned “ON”. From FIG. 7, it can be realised that a significant amount of particles again had passed right through the oven.
g. The inside was then analysed. Samples were taken from the inner side of the oven. From this sample, FIG. 8, it was seen that large and very dense aggregates of particles could be detected. Apparently, the combined affect of water vapours and microwaves condenses/sintering the small and finest air-borne particles very efficiently. In this way, the air-borne particles are immobilised and removed from the dangerous aerosol phase and accumulated on the inner surface of the oven.

### Example 2

### Direct Measurements of Particle Sizes from Diesel Exhaust

The set-up was similar to that of Example 1 except where otherwise stated. A series of experiments have been preformed on diesel exhaust gas from a loaded car engine where the particle size distribution was examined with and without applied electromagnetic radiation in the form of a microwave oven (volume approx 15 L) together with and without water vapour. The treated gas from the microwave oven was passed through a diluter arranged upstream relative to the sensitive particle counter (SMPS, Scanning mobility particle sizer+APS, Aerodynamical particle sizer).

The particle size distributions (results from the SMPS) are presented for the various cases of experiments:

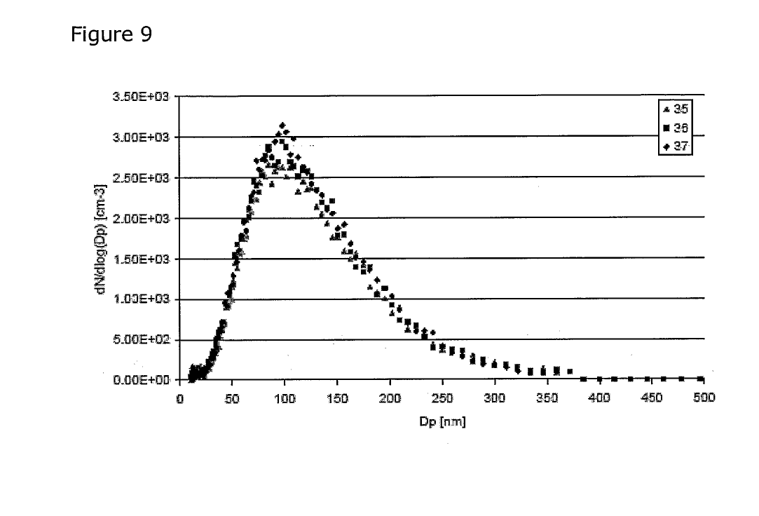

A. Diesel exhaust gas from a hot engine without microwave application and without addition of water vapour (FIG. 9).

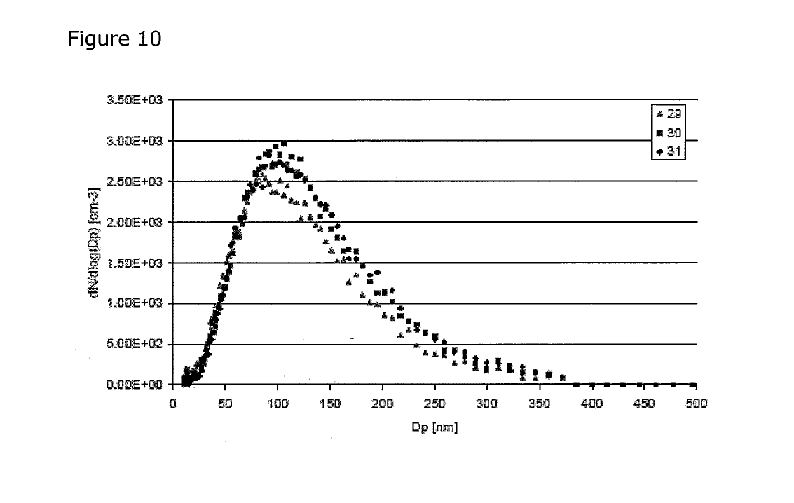

B. Diesel exhaust gas from a hot engine without microwave application but with addition of water vapour (FIG. 10).

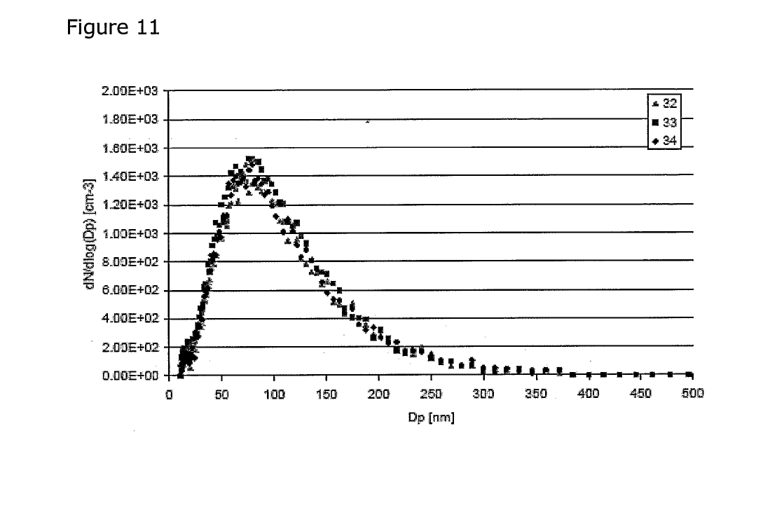

C. Diesel exhaust gas from a hot engine with microwave application and with addition of water vapour (FIG. 11).

The conclusion drawn down from these distributions is that, measured on the fly, the particle distribution is affected when both microwave and vapour is applied to the diesel exhaust resulting in an overall decrease of at least 50% determined as the particle distribution peak at approx. 100 nm.

Thus, the method and apparatus of the invention effectively reduces the number of nanoparticles, even without any optimization of the process parameters.

1. A method of purifying a flow of an exhaust gas from a Diesel engine which is contaminated with a particulate material using an apparatus comprising (i) a conduit for passage of the exhaust gas flow, (ii) means for applying electromagnetic radiation at a frequency of in the range of 10 MHz to 100 GHz in at least one zone within said conduit, and (iii) means for supplying a dipolar liquid to said zone of said conduit, said method comprising the steps of
(a) allowing the contaminated gas to flow through the conduit; and
(b) applying the electromagnetic radiation to said gas and said liquid in said zone of said conduit.

2. The method according to claim 1, wherein the dipolar liquid is water.

3. The method according to claim 1, wherein the dipolar liquid preferably introduced into the zone in the form of a vapour or an aerosol, or is turned into a vapour or an aerosol upon application of the electromagnetic radiation.

4. The method according to claim 1, wherein at least 100 grams of vapour and/or aerosols of the dipolar liquid are supplied per m³ per minute.

5. The method according to claim 1, wherein the passage time for the gas through said at least one zone is in the range of 0.01-100 s.

6. The method according to claim 1, wherein the effect density of the electromagnetic radiation in said zone is in the range of 0.01-50 kW/m³.

7. The method according to claim 1, wherein the density of the particulate material is less than 10¹⁵ particles per m³ in the gas exiting the conduit.

8. The method according to claim 1, wherein the number of nanoparticles in the gas is reduced by at least 30%.

9. The method according to claim 1, wherein the contaminated gas is the exhaust gas from a Diesel engine.

10. The method according to claim 1 which includes the further step of collecting and recycling at least a portion of the dipolar liquid.

11. A diesel engine exhaust system for purifying a continuous exhaust gas flow contaminated with particulate material(s), said exhaust system comprising (i) a conduit for passage of the exhaust gas flow, (ii) means for applying electromagnetic radiation at a frequency of in the range of 10 MHz to 100 GHz in at least one zone of said conduit, and (iii) means for supplying a dipolar liquid to said zone of said conduit.

12. The system according to claim 11, wherein the dipolar liquid is water.

13. The system according to claim 11, which comprises means for providing the dipolar liquid into the zone in the form of a vapour or an aersol.

14. The system according to claim 11, wherein the means for supplying water to said zone is arrange within said zone of the conduit.

15. The system according to claim 11 which further comprising means for collecting and recycling at least a portion of the dipolar liquid.
